(19) United States
(12) Patent Application Publication
(10) Pub. No.: US 2011/0015978 A1
(43) Pub. Date: Jan. 20, 2011

(54) COUPON DISPENSING SYSTEMS AND METHODS

(75) Inventor: Charles D. Welch, JR., St. Joseph, MO (US)

Correspondence Address: POLSINELLI SHUGHART PC, 700 W. 47TH STREET, SUITE 1000, KANSAS CITY, MO, 64112-1802, US

(73) Assignee: ROUTESYNC, LLC, Lenexa, KS (US)

(21) Appl. No.: 12/796,115

(22) Filed: Jun. 8, 2010

Related U.S. Application Data
(60) Provisional application No. 61/226,930, filed on Jul. 20, 2009.

(51) Int. Cl. G06Q 30/00; G06Q 10/00; G06F 17/30

(52) U.S. Cl. 705/14.15; 705/14.25; 705/14.26; 707/802; 707/769; 707/E17.005; 707/E17.014

(57) ABSTRACT

Systems and methods are provided for dispensing coupons in response to a purchase request for a requested good or service received from a consumer. A processing system executes a coupon dispensing application to manage the dispensing of coupons. The coupon dispensing application communicates with a coupon management system to identify available coupons for the requested good or service in response to the purchase request. The coupon dispensing application may also communicate with a benefit provider system to determine a benefit amount provided to the consumer for the requested good or service. The coupon dispensing application determines a payment amount for the requested good or service based on an available coupon, a determined benefit amount, and/or a purchase amount for the requested good or service.

### RELATED APPLICATIONS

This application takes priority to U.S. patent application No. 61/226,930, filed Jul. 30, 2009, and entitled Coupon Dispensing Systems and Methods, the entire contents of which are incorporated herein by reference.

### FEDERALLY SPONSORED RESEARCH OR DEVELOPMENT

Not Applicable.

### COMPACT DISK APPENDIX

Not Applicable.

### BACKGROUND

Product manufacturers and service providers often offer coupons to generate an incentive for consumers to purchase their goods or services. Coupons can also be used to advertise and/or create brand recognition for a good or service. Whether or not a particular coupon is effective depends, in large part, on whether a sufficient number of consumers redeem that particular coupon when purchasing a good or service. Thus, the effectiveness of coupons can be measured in terms of redemption rates. It is estimated that the redemption rate for conventional coupons is between two to five percent (2%-5%) and, thus, are not very effective.

Redemption rates can be influenced by various factors. For example, the method used to distribute coupons can affect the redemption rate. Most coupons are distributed through magazines, newspapers and other distributed printed media, and consumers typically discover such coupons at home, work, or other areas remote from stores in which the coupons may be redeemed. As a result, coupons distributed in this manner do not typically generate impulse-based sales. The perception of consumers with respect to acquiring and maintaining coupons can also affect the redemption rate. For example, some consumers prefer not to deal with the inconvenience of clipping coupons and then saving the coupons until the need for a particular product arises. If the consumer does not have a present need for a product, there is lack of incentive to save the coupon.

Moreover, the process of redeeming coupons at some business can be inconvenient. For example, the process of redeeming a coupon for a prescribed medication at a pharmacy can be inconvenient for both the customer and the pharmacy. As an example, after a physician writes a prescription for a patient, the physician may hand the prescription to the patient or send the prescription to a pharmacy via, for example, a fax machine or an electronic communication. The physician may also provide the patient a coupon to receive a discount on the prescribed medication. Thereafter, the patient goes to the pharmacy to pick up the filled prescription or to give the prescription to the pharmacy to be filled and picked up later. The pharmacy performs the steps to fill the prescription and submits information to the insurance companies where applicable. The pharmacy then prints a label to place on a bottle and/or bag containing the prescribed medication and prints a receipt that is presented to a clerk at a register. The patient/customer then presents the coupon to the clerk at the register. At this point, however, the prescription needs to go back to the pharmacy so that the coupon/voucher information can be entered into the pharmacy system. The pharmacy then reprints the label and receipt and prints the coupon/voucher information. The patient/customer must now wait for the information to be reprocessed. The time that other pharmacy customers must wait for service is also extended. Such a redemption process can discourage the customer from redeeming coupons at a pharmacy and/or interfere with the workflow of the pharmacy.

Thus, there is a need for coupon dispensing system and method that increases coupon redemption without interfering with the workflow of a business.

### SUMMARY

According to one aspect, a computer readable media encoded with an application including modules executable by a processor and configured to dispense coupons in response to a purchase request received from a computing device. The application includes a query module to receive the purchase request. The purchase request includes at least one of benefit data and purchase data. The benefit data identifies a benefit provider system and a benefit plan. The purchase data identifies a requested item. The query module also generates a query to search a plurality of coupon records stored in a coupon database. Each coupon record includes coupon data identifying a coupon, a corresponding coupon identification code, a corresponding discount amount, and corresponding eligible items. The query module also compares the requested item to the coupon data included in each of the coupon records to identify a particular coupon as available for the purchase request. The application also includes a storage module to receive a coupon response that includes corresponding coupon data for the particular coupon and to store the corresponding coupon data and the purchase data in a memory. The application also includes a benefit determination module to determine whether the purchase request includes benefit data and to generate a validation request when the purchase request includes benefit data. The validation request identifies the benefit plan. The benefit determination module also submits the validation request to the benefit provider system to illicit a validation response. The validation response specifies a benefit amount for the benefit plan. The application also includes a payment calculation module to calculate an amount of payment due for the requested item based on at least two of the benefit amount, the discount amount specified by the corresponding coupon data, and a purchase cost for the requested item. The application also includes a coupon generation module to transmit a payment due notification to the computing device. The payment due notification comprises the amount of payment due.

According to another aspect, a system for dispensing coupons in response to a purchase request received from a computing device. The system includes a database to store a plurality of coupon records and a processing device that includes a coupon dispensing application. The coupon dispensing application includes modules that are executable by the processing device. The coupon dispensing application includes a query module to receive the purchase request. The purchase request includes at least one of benefit data and purchase data. The benefit data identifies a benefit provider system and a benefit plan. The purchase data identifies a requested item. The query module also generates a query to search a plurality of coupon records stored in a coupon database. Each coupon record includes coupon data identifying a coupon, a corresponding coupon identification code, a corresponding discount amount, and corresponding eligible goods or services. The query module also compares the requested item to the coupon data included in each of the coupon records to identify a particular coupon as available for the purchase request. The coupon dispensing application also includes a storage module to receive a coupon response including coupon data for the particular coupon and to store the corresponding coupon data and the purchase data in a memory. The coupon dispensing application also includes a benefit determination module to determine whether the purchase request includes benefit data and to generate a validation request when the purchase request includes benefit data. The validation request identifies the benefit plan. The benefit determination module also submits the validation request to the benefit provider system to illicit a validation response. The validation response specifies a benefit amount for the benefit plan. The application also includes a payment calculation module to calculate an amount of payment due for the requested item based on at least two of the benefit amount, the discount amount specified by the corresponding coupon data, and a purchase cost for the requested item. The coupon dispensing application also includes a coupon generation module to transmit a payment due notification to the computing device. The payment due notification comprises the amount of payment due.

According to another aspect, a method for dispensing coupons in response to a purchase request received from a processing device. The method includes receiving the purchase request at a processor. The purchase request includes at least one of benefit data and purchase data. The benefit data identifies a benefit provider system and a benefit plan. The purchase data identifies a requested item. The method also includes generating a query, at the processor, to search a plurality of coupon records stored in a coupon database. Each coupon record includes coupon data identifying a coupon, a corresponding coupon identification code, a corresponding discount amount, and corresponding eligible items. The method also includes comparing the requested item to the coupon data included in each of the coupon records in the coupon database to identify a particular coupon as available for the purchase request. The method also includes receiving a coupon response including corresponding coupon data for the particular coupon at the processor. The method also includes storing the corresponding coupon data and the purchase data in a memory. The method also includes determining whether the purchase request includes benefit data and generating a validation request at the processor when the purchase request includes benefit data. The validation request identifies the benefit plan sending the validation request to the benefit provider system to illicit a validation response. The validation response specifies a benefit amount for the benefit plan. Calculating an amount of payment due for the requested item based on at least two of the benefit amount, the discount amount specified by the corresponding coupon data, and a purchase cost for the requested item. The method also includes transmitting a payment due notification to the processing device. The payment due notification including the amount of payment due.

According to another aspect, a computer readable media is encoded with an application including modules executable by a processor and configured to dispense coupons in response to a purchase request received from a computing device. The application includes a query module to receive the purchase request. The purchase request includes purchase data that identifies a requested item. The query module also generates a query to search a plurality of coupon records stored in a coupon database. Each coupon record includes coupon data identifying a coupon, a corresponding coupon identification code, a corresponding discount amount, and corresponding eligible items. The query module also compares the requested item to the coupon data included in each of the coupon records to identify a particular coupon as available for the purchase request. The application also includes a payment calculation module to calculate an amount of payment due for the requested item based on the discount amount specified by the corresponding coupon data and a purchase cost for the requested item. The application also includes a coupon generation module to transmit a payment due notification to the computing device. The payment due notification includes the amount of payment due.

### BRIEF DESCRIPTION OF THE DRAWINGS

FIG. 1 is a block diagram of a coupon dispensing system in accordance with an aspect of the present invention.

FIG. 2 is a block diagram depicting communications between a business management system, a coupon management system, and a business management system according to one aspect of the coupon dispensing system.

FIG. 3 is a block diagram of a coupon dispensing application according to one aspect of a coupon dispensing system.

FIG. 4 is a flow chart illustrating a coupon dispensing method in accordance with an aspect of a coupon dispensing system.

### DETAILED DESCRIPTION

Aspects of the coupon dispensing system (CDS) described herein provide the ability to have a discount amount associated with a coupon automatically deducted from the cost of a requested item, such as a good or service, without prior knowledge of a customer purchasing the requested good or service. The value or discount amount of the coupon can also be applied without prior knowledge of a business selling the requested item. For example, the CDS identifies available coupons by processing a purchase request received from a computing device to identify the requested item. The CDS then searches a coupon database to determine if a coupon is available for the requested item. If a coupon is available, the CDS automatically deducts the value associated with the coupon from the cost of the item. By automatically identifying coupons and deducting the coupon value from the cost of the requested item, the CDS eliminates need for customers to locate coupons prior to purchasing and eliminates the need for businesses manage the dispensing of coupons.

Other aspects of the CDS provide the ability to determine an amount of the purchase cost of the item that may be subsidized, or paid, by a third party source, such as an insurance provider. The CDS then deducts the coupon value from the portion of the purchase cost that is not covered by the third party.

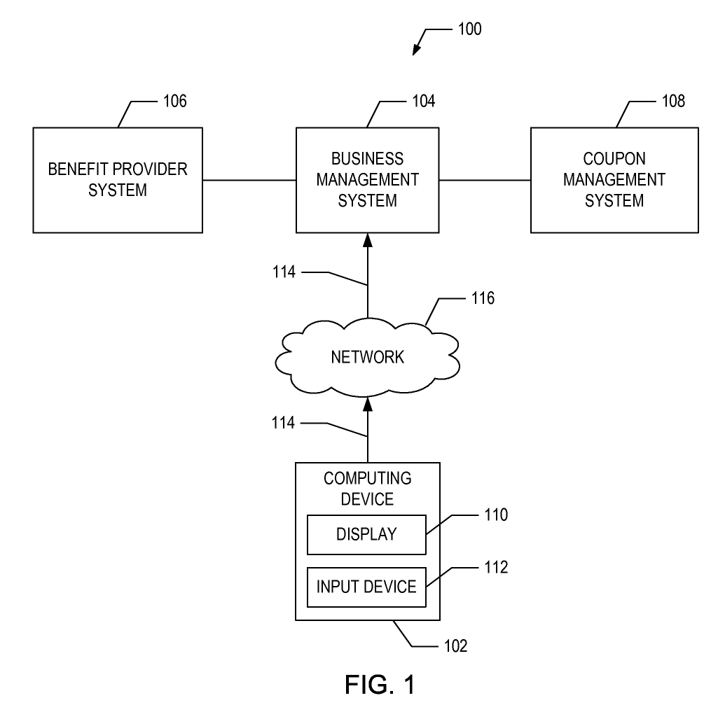

FIG. 1 depicts an exemplary embodiment of a CDS 100. The CDS 100 includes at least one computing device 102, a business management system 104, a benefit provider system 106, and a coupon management system 108. Although one computing device 102 is depicted in FIG. 1, the CDS 100 may include multiple computing devices.

According to one aspect, the computing device 102 is a computer or processing device, such as a personal computer, a server computer, or a mobile processing device. The computing device 102 includes one or more processors that process software or other machine-readable instructions and includes a memory to store the software or other machine-readable instructions and data. The memory may include volatile and/or non-volatile memory. The computing device 102 may also include a communication system to communicate via wireline and/or wireless communications, such as through the Internet, an intranet, an Ethernet network, a wireline network, a wireless network, and/or another communication network. The computing device 102 may further include a display 110 for viewing data, such as a computer monitor, and an input device 112, such as a keyboard or a pointing device (e.g., a mouse, trackball, pen, touch pad, or other device), for entering data and navigating through data, including exams, images, documents, structured data, unstructured data, HTML pages, other web pages, and other data.

An authorized user or representative of a business uses the computing device 102 to generate a purchase request for a customer that desires to purchase a particular good and/or service from the business. For example, the authorized user, such as a pharmacist, uses the input device 112 associated with the computing device 102 to enter purchase data and/or benefit data for a customer requesting to have a prescription for a particular a medication filled or refilled. The computing device 102 generates a prescription purchase request (“purchase request”) 114 in response to the entered purchase and/or benefit data. In this example, the purchase data corresponds to prescription purchase data and includes, for example, a physician name, a requested medication type, and medication amount. The benefit data corresponds to prescription benefit data and includes, for example, a benefit coverage type, a Beneficiary Identification Number (BIN), a Process Control Number (PCN), Group name, and other plan identification data. The BIN, PCN, and Group name identify, a particular insurance carrier, a process control number, and a particular insurance group plan, respectively, for the customer. The generated purchase request 114 includes the purchase data and the benefit data.

According to another aspect, the computing device 102 communicates the purchase request 114 to the business management system 104 via a network 116. The network 116 can be the Internet, an intranet, or another communication network. Although the invention is described herein in connection with a business process related to purchasing medication at a pharmacy, it is contemplated that the principles and aspects described herein can be applied to any other business process in which a purchase request 114 is generated for purchasing an item. It is also contemplated that the user of the computing device 102 can be a consumer. For example, a consumer uses the input device 112 associated with the computing device 102 to enter purchase data to generate the purchase request 114 and initiate the purchase of an item from a Web site of a retailer via the Internet.

The benefit provider system 106 maintains benefit records for enrollees in one or more benefit plans of a benefit provider, such as a healthcare insurance provider. The benefit records specify various benefit plans that outline benefits that enrollees are eligible to receive. For example, a benefit provided to an enrollee may be that the enrollee's payment for a requested medication is limited to a maximum of twenty dollars. The benefit provider pays the remainder of the purchase amount. The amount paid by the enrollee is referred to herein as the “co-payment.”

In one aspect, the business management system 104 communicates with the benefit provider system 106 in response to the purchase request 114 to determine if a benefit is available for the requested prescription. For example, the business management system 104 communicates with the benefit provider system 106 to determine whether a particular customer requesting a particular medication is eligible for a benefit, whether the particular medication is eligible for a benefit, and/or an amount of an available benefit.

The coupon management system 108 stores one or more coupon records. Each coupon record includes coupon data that identifies, for example, a corresponding coupon, one or more medications eligible for the corresponding coupon, and a unique coupon identification (ID) code for the corresponding coupon. According to one aspect, the business management system 104 communicates with the coupon management system 108 in response to the purchase request 114 to determine whether a coupon or a voucher is available for the requested medication. For example, the business management system 104 transmits a query to the coupon management system 108 in response to the purchase request 114. The query includes, for example, the purchase data entered by the pharmacist. In one example, the business management system 104 receives coupon data from the coupon management system 108 that matches the purchase data included in the query.

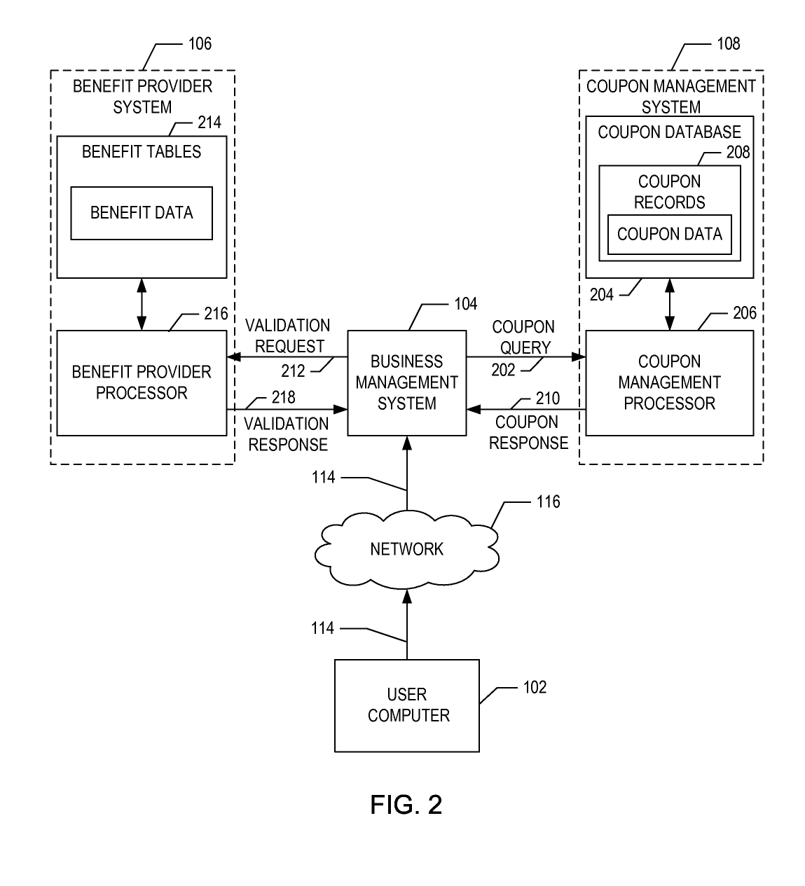

FIG. 2 is a block diagram that depicts communications between the business management system 104, the benefit provider system 106, and the coupon management system 108 according to one aspect of the CDS 100.

The business management system 104 generates a coupon query 202 in response to the purchase request 114 received from the computing device 102. The business management system 104 transmits the coupon query 202 to the coupon management system 108 to search for and/or retrieve coupons.

The coupon management system 108 includes a coupon database 204 and a coupon management processor 206. The coupon database 204 stores one or more coupon records 208. As described above, each coupon record 208 includes coupon data that identifies a corresponding coupon, one or more medications eligible for the corresponding coupon, and the unique coupon ID code for the corresponding coupon. According to other aspects, each coupon record 208 may include other coupon data, such as manufacturers eligible for the corresponding coupon, benefit plans eligible for the corresponding coupon, businesses eligible for the corresponding coupon, and/or other coupon eligibility data.

The coupon management processor 206 is, for example, a server, a computer, or other processing device that processes the coupon query 202 to identify purchase data. The coupon management processor 206 then searches the coupon database 204 to identify coupon records 208 that include coupon data that matches the identified purchase data and generates a coupon response 210. In one aspect, the querying involves comparing the purchase data included in the coupon query 202 to the coupon data included in each coupon record 208 to identify matching data. For example, if the medication identified by the purchase data included the coupon query 202 matches a medication included in the coupon data of a particular coupon record 208, the coupon management processor 206 generates a coupon response 210 that includes that particular coupon record 208.

According to one aspect, the business management system 104 receives the coupon response 210 and then generates a benefit validation request 212 that includes the benefit data. The business management system 104 transmits the benefit validation request 212 to the benefit provider system 108 to determine whether a benefit is available for the medication identified by purchase request 114 and/or the amount of an available benefit.

The benefit provider system 106 includes one or more benefit tables 214 and a benefit provider processor 216. Each benefit table 214 includes eligible benefit plans. Each benefit plan specifies benefit data for enrollees of that particular benefit plan. Benefit data includes, for example, name data, address data, employment data, insurance plan data, and other data for enrollees. The benefit provider processor 216 is, for example, a server, a computer, or other processing device that processes the benefit validation request 212 to identify benefit data, such as a BIN, a PCN, and/or requested medication data. The benefit provider processor 216 then queries the benefit tables 214 to determine whether benefit data included in the validation request 212 correspond to an enrollee of a particular benefit plan and to identify any benefits that the enrollee is eligible to receive for the requested medication.

In one aspect, querying the benefit tables involves comparing the benefit data included in the benefit validation request 212 to the benefit data included in each of the benefit tables to identify matching benefit data. For example, if the benefit plan, BIN, and/or PCN identified by benefit data included the benefit validation request 212 matches BIN and/or PCN for an enrollee included in a particular benefit table, the benefit provider processor 216 generates a validation response 218 that includes corresponding available benefit, such as a benefit amount, for that enrollee. If the BIN and/or PCN identified by the benefit data included in the benefit validation request 212 do not match any of the BIN and/or PCN data for enrollees included in the benefit tables 214, the benefit provider processor 216 generates a validation response 218 that indicates there are no benefits available. Thus, the validation response 218 specifies whether the purchase request 114 is eligible for a benefit and, if eligible, the amount of the benefit.

Although the business management system 104 is described in FIG. 2 as transmitting a validation request 212 to one benefit provider system 106, it is contemplated that the business management system 104 may generate and transmit multiple validation requests 212 in response to a single prescription request 114. For example, the benefit data included in the purchase request 114 may indicate that the customer has primary insurance, secondary insurance, and/or a tertiary insurance. In this example, the business management system 104 may receive multiple validation responses 218 from multiple benefit provider systems 106 each indicating a benefit amount.

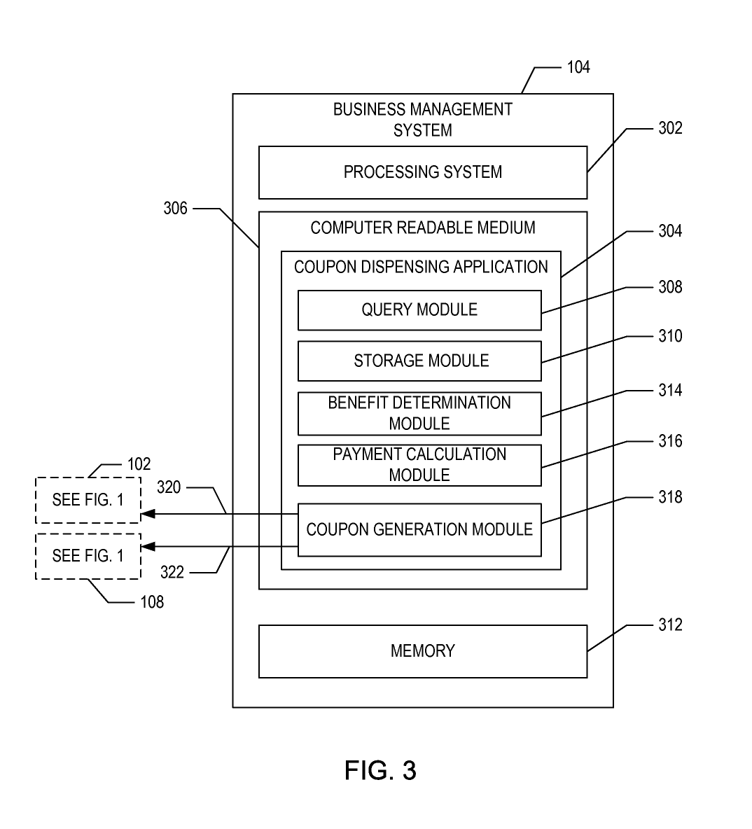

FIG. 3 is a block diagram that depicts an exemplary business management system 104. According to one aspect, the business management system 104 includes a processing system 302 that executes a coupon dispensing application 304 to manage the dispensing of coupons. The processing system 302 includes a processor, and the processing system 302 can be a computer or other processing device.

The coupon dispensing application 304 includes instructions or modules that are executable by the processing system 302 of the business management system 104 to generate and/or manage the dispensing of coupons. The business management system 104 includes a computer readable media 306 configured with the coupon dispensing application 304.

The computer readable media (CRM) 306 may include volatile media, nonvolatile media, removable media, non-removable media and/or another available medium that can be accessed by the business management system 104. By way of example and not limitation, computer readable media 306 comprises computer storage media and communication media. Computer storage media includes memory, volatile media, nonvolatile media, removable media, and/or non-removable media implemented in a method or technology for storage of information, such as computer readable instructions, data structures, program modules, or other data. Communication media may embody computer readable instructions, data structures, program modules, or other data and include an information delivery media or system.

A query module 308 generates the coupon query 202 in response to the purchase request 114. The query module 308 then transmits the coupon query 202 to the coupon management system 108. The coupon management system 108 processes the coupon query 202 as described above to determine if there is a coupon available for the requested medication and generates the coupon response 210.

A storage module 310 receives the coupon response 210 and stores the coupon data and the purchase data in a memory 312. The memory 312 includes, for example, one or more files each comprising coupon data and the purchase data that corresponds to a particular purchase request 114.

A benefit determination module 314 determines whether the purchase request 114 comprises the benefit data and generates the validation request 212 when the purchase request 114 comprises the benefit data. The benefit determination module 314 then transmits the validation request 212 to the benefit provider system 106. The benefit provider system 106 processes the validation request 212 as described above and generates the validation response 218.

A payment calculation module 316 receives the validation response 218 from the benefit provider system 106. The validation response 218 specifies the benefit amount available for the purchase request 114. The payment calculation module 316 retrieves the coupon data from the memory 312 for the corresponding purchase request 114 to determine the discount value. The payment calculation module 316 then calculates the amount of payment due for the requested medication based on the benefit amount, the discount value, and/or the purchase cost of the requested medication. For example, if the benefit amount specifies a maximum payment, or co-payment, amount for an enrollee, the payment calculation module 316 calculates the amount of payment due by subtracting the discount value from the co-payment amount.

If the purchase request 114 does not include benefit data or the benefit data indicates that the customer is not enrolled in a benefit plan or there is no benefit amount for the request medication, the payment calculation module 316 calculates the amount of payment due, for example, by subtracting the discount value from the purchase cost of the requested medication.

According to another aspect, the payment calculation module 316 limits the discount value to the maximum payment amount. For example, assume a customer A and a customer B request the same medication, and that a coupon specifies that a discount value of twenty ($20) dollars is available for the requested medication. Further assume that customer A's benefit plan specifies a co-payment of twenty dollars and that customer B's benefit plan specifies a co-payment of fifteen ($15) dollars. In this example, the amount of payment due calculated by the payment calculation module 316 is zero ($0) dollars for both customer A and customer B. Thus, customer A receives the full discount of twenty ($20) dollars, but customer B's discount is limited to fifteen ($15) dollars.

According to another aspect, the payment calculation module 316 calculates a consolidated benefit amount in response to receiving multiple validation responses 218. As described above, if the customer has primary insurance, secondary insurance, and/or a tertiary insurance, the business management system 104 may receive multiple validation responses 218. According to this aspect, the payment calculation module 316 calculates the amount of payment due for the requested medication based on the consolidated benefit amount and the discount value.

A coupon generation module 318 generates a payment due notification 320 for transmission to the computing device 102. The payment due notification 320 includes the amount of payment due for the requested medication and coupon data for display on the display 110 of the computing device 102. According to another aspect, the user of the computing device 102 can interact with the input device 112 to generate a hard copy of the coupon data. For example, the user of the computing device 102 interacts with the input device 112 to send the coupon data to an output device, such as a printer, to generate a coupon receipt. The coupon receipt can be provided to the customer and may be the first time the customer and/or the user of the computing device 102 is aware of the coupon.

According to another aspect, the coupon generation module 318 generates a dispensed coupon notification 322 for transmission to the coupon management system 108. The dispensed coupon notification 322 includes the corresponding coupon ID code for the particular coupon used to calculate the amount of payment due for the requested medication. The coupon management system 108 processes the dispensed coupon notification 322 to identify the coupon ID code and updates the coupon record 208 associated with the identified coupon ID. For example, the updating includes updating a coupon count included in the associated coupon record 208. The coupon count tracks, for example, the number of successful dispenses of a corresponding coupon (e.g., redemption rate).

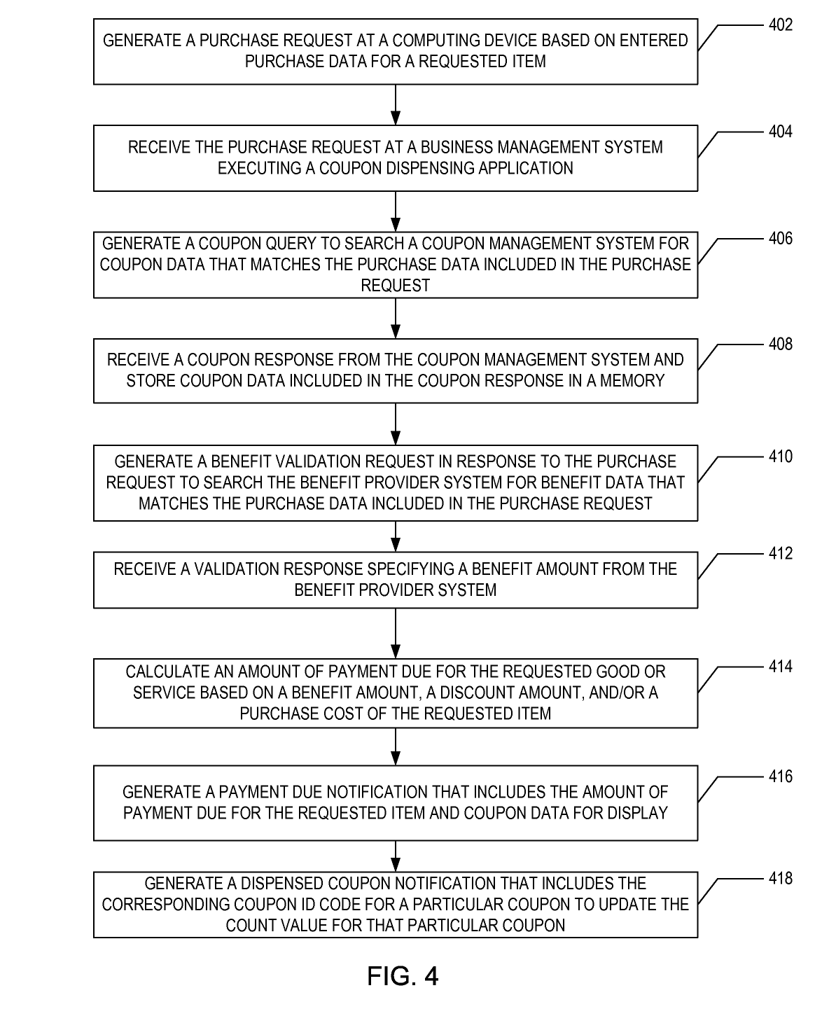

FIG. 4 illustrates a method for managing the dispensing of coupons from a pharmacy system in response to a purchase request 114. A user enters purchase data and/or benefit data for a requested item, such as a medication, into the computing device 102 to generate a purchase request at 402. At 404, the business managements system 104 executing the coupon dispensing application 304 receives the purchase request 114. The coupon dispensing application 304 generates a coupon query 208 in response to the purchase request 114 to search the coupon dispensing system 108 for coupon data that matches the purchase data included in the purchase request 114 at 406. For example, the coupon data specifies a discount amount for the requested medication. At 408, the coupon dispensing application 304 receives the coupon response 210 from the coupon dispensing system 108 and stores coupon data included in the coupon response 210 in the memory 312. The coupon dispensing application 304 generates a benefit validation request 212 in response to the purchase request 114 to search the benefit provider system 106 for benefit data that matches the benefit data included in the purchase request 114 at 410. As described above, the benefit data specifies a benefit amount available for the customer for the requested medication. At 412, the coupon dispensing application 304 receives the validation response 210 specifying the benefit amount from the benefit provider system 106. The coupon dispensing application 304 calculates the amount of payment due for the requested medication based on the benefit amount, the discount amount, and/or the purchase cost of the requested medication at 414. The coupon dispensing application 304 generates the payment due notification 320 that includes the amount of payment due for the requested medication and coupon data for display on the display 110 of the computing device 102 at 416. At 418, the coupon dispensing application 304 generates the dispensed coupon notification 322 that includes the corresponding coupon ID code for the particular coupon used to update the count value for that particular coupon.

Those skilled in the art will appreciate that variations from the specific embodiments disclosed above are contemplated by the invention. The invention should not be restricted to the above embodiments, but should be measured by the following claims.

What is claimed is:

1. A computer readable media encoded with an application comprising modules executable by a processor and configured to dispense coupons in response to a purchase request received from a computing device, the application comprising:
a query module to:
receive the purchase request, the purchase request comprising at least one of benefit data and purchase data, the benefit data identifying a benefit provider system and a benefit plan, and the purchase data identifying a requested item;
generate a query to search a plurality of coupon records stored in a coupon database, wherein each of the plurality of coupon records comprise coupon data identifying a coupon, a corresponding coupon identification code, a corresponding discount amount, and corresponding eligible items; and
compare the requested item to the coupon data comprised in each of the coupon records to identify a particular coupon as available for the purchase request;
a storage module to:
receive a coupon response comprising corresponding coupon data for the particular coupon; and
store the corresponding coupon data and the purchase data in a memory;
a benefit determination module to:
determine whether the purchase request comprises the benefit data;
generate a validation request when the purchase request comprises the benefit data, the validation request identifying the benefit plan; and
submit the validation request to a benefit provider system to illicit a validation response, the validation response specifying a benefit amount for the benefit plan;
a payment calculation module to calculate an amount of payment due for the requested item based on at least two of the benefit amount, the corresponding discount amount specified by the corresponding coupon data, and a purchase cost for the requested item; and
a coupon generation module to transmit a payment due notification to the computing device, the payment due notification comprising the amount of payment due.

2. The computer readable media of claim 1 wherein the payment calculation module is further configured to:
determine the amount of payment due is equal to a first payment amount when the purchase request comprises the benefit data; and
determine the amount of payment due is equal to a second payment amount when the purchase request does not comprise the benefit data.

3. The computer readable media of claim 1 wherein:
the benefit provider system comprises a benefit table that comprises a list of eligible benefit plans and corresponding benefit amounts for each eligible benefit plan, and wherein the benefit provider system compares the benefit plan to the list of eligible benefit plans to identify a matching benefit plan; and
the validation response specifies the benefit amount for the matching benefit plan.

4. The computer readable media of claim 1 wherein:
the purchase data comprises an item type, an item amount, and a manufacturer name;
the benefit data comprises a beneficiary identification number, a processing control number, and a group name, a customer name; and
the benefit determination module is further configured to identify the benefit provider and the benefit plan based on at least one of the beneficiary identification number, the processing control number, and the group name.

5. The computer readable media of claim 1 wherein the coupon generation module is further configured to generate a coupon receipt for display and/or printing at the computing device.

6. The computer readable media of claim 1 wherein the coupon generation module is further configured to:
generate a dispensed coupon notification, the dispensed coupon notification comprising the corresponding coupon identification for the particular coupon identified as available; and
transmit the dispensed coupon notification to a coupon management system, wherein the coupon management system is configured to identify the coupon record comprising the corresponding coupon identification and to update a coupon count included in the coupon record.

7. The computer readable media of claim 1 wherein the payment calculation module is further configured to determine the payment amount based only on the corresponding discount amount when the purchase request does not comprise the benefit data.

8. The computer readable media of claim 1 wherein the benefit amount comprises a co-payment amount, and wherein the payment calculation module is further configured to adjust the corresponding discount amount not to exceed the co-payment amount.

9. The computer readable media of claim 1 wherein the query module is further configured to:
receive another purchase request from the computing device, the other purchase request comprising different purchase data identifying another requested item; and
generate another query to:
first search the corresponding coupon data for the particular coupon previously stored in the memory;
compare the other requested item to the corresponding coupon data to determine if there is match coupon data;
identify the particular coupon as available for the other requested item when there is matching coupon data;
second search the plurality of coupon records stored in the coupon database when there is no matching coupon data; and
compare the other requested item to the coupon data comprised in each of the coupon records to identify another particular coupon as available for the purchase request.

10. A system for dispensing coupons in response to a purchase request received from a computing device, the system comprising:
a database to store a plurality of coupon records;
a processing device comprising a coupon dispensing application comprising modules executable by the processing device, the coupon dispensing application comprising:
a query module to:
receive the purchase request, the purchase request comprising at least one of benefit data and purchase data, the benefit data identifying a benefit provider system and a benefit plan, and the purchase data identifying a requested item;
generate a query to search a plurality of coupon records stored in a coupon database, wherein each of the plurality of coupon records comprise coupon data identifying a coupon, a corresponding coupon identification code, a corresponding discount amount, and corresponding eligible items; and
compare the requested item to the coupon data comprised in each of the coupon records to identify a particular coupon as available for the purchase request;
a storage module to:
receive a coupon response comprising corresponding coupon data for the particular coupon; and
store the corresponding coupon data and the purchase data in a memory;
a benefit determination module to:
determine whether the purchase request comprises the benefit data;
generate a validation request when the purchase request comprises the benefit data, the validation request identifying the benefit plan; and
submit the validation request to a benefit provider system to illicit a validation response, the validation response specifying a benefit amount for the benefit plan;
a payment calculation module to calculate an amount of payment due for the requested item based on at least two of the benefit amount, the corresponding discount amount specified by the corresponding coupon data, and a purchase cost for the requested item; and
a coupon generation module to transmit a payment due notification to the computing device, the payment due notification comprising the amount of payment due.

11. The system of claim 10 wherein the payment calculation module is further configured to:
determine the amount of payment due is equal to a first payment amount when the purchase request comprises the benefit data; and
determine the amount of payment due is equal to a second payment amount when the purchase request does not comprise the benefit data.

12. The system of claim 10 wherein:
the benefit provider system comprises a benefit table that comprises a list of eligible benefit plans and corresponding benefit amounts for each eligible benefit plan, and wherein the benefit provider system compares the benefit plan to the list of eligible benefit plans to identify a matching benefit plan; and
the validation response specifies the benefit amount for the matching benefit plan.

13. The system of claim 10 wherein:
the purchase data comprises an item type, an item amount, and a manufacturer name;
the benefit data comprises a beneficiary identification number, a processing control number, and a group name, a customer name; and
the benefit determination module is further configured to identify the benefit provider and the benefit plan based on at least one of the beneficiary identification number, the processing control number, and the group name.

14. The system of claim 10 further comprising a wherein the coupon generation module is further configured to generate a coupon receipt for display and/or printing.

15. The system of claim 10 wherein the coupon generation module is further configured to:
generate a dispensed coupon notification, the dispensed coupon notification comprising the corresponding coupon identification for the particular coupon identified as available; and
transmit the dispensed coupon notification to a coupon management system, wherein the coupon management system is configured to identify the coupon record comprising the corresponding coupon identification and to update a coupon count included in the coupon record.

16. The system of claim 10 wherein the payment calculation module is further configured to determine the payment amount based only on the corresponding discount amount when the purchase request does not comprise the benefit data.

17. The system of claim 10 wherein the benefit amount comprises a co-payment amount, and wherein the payment calculation module is further configured to adjust the corresponding discount amount not to exceed the co-payment amount.

18. The system of claim 10 wherein the query module is further configured to:
receive another purchase request from the computing device, the other purchase request comprising different purchase data identifying another requested item; and
generate another query to:
first search the corresponding coupon data for the particular coupon previously stored in the memory;
compare the other requested item to the corresponding coupon data to determine if there is match coupon data;
identify the particular coupon as available for the other requested item when there is matching coupon data;
second search the plurality of coupon records stored in the coupon database when there is no matching coupon data; and
compare the other requested item to the coupon data comprised in each of the coupon records to identify another particular coupon as available for the purchase request.

19. A method for dispensing coupons in response to a purchase request received from a processing device, the method comprising:
receiving the purchase request at a processor, the purchase request comprising at least one of benefit data and purchase data, the benefit data identifying a benefit provider system and a benefit plan, and the purchase data identifying a requested item;
generating a query at the processor to search a plurality of coupon records stored in a coupon database, wherein each of the plurality of coupon records comprise coupon data identifying a coupon, a corresponding coupon identification code, a corresponding discount amount, and corresponding eligible goods or services;
comparing the requested item to the coupon data comprised in each of the coupon records in the coupon database to identify a particular coupon as available for the purchase request;
receiving a coupon response comprising corresponding coupon data for the particular coupon at the processor;
storing the corresponding coupon data and the purchase data in a memory;
determining whether the purchase request comprises the benefit data;
generating a validation request at the processor when the purchase request comprises the benefit data, the validation request identifying the benefit plan;
sending the validation request to another processor to illicit a validation response, the validation response specifying a corresponding benefit amount for the benefit plan;
calculating an amount of payment due for the requested item based on at least two of the benefit amount, the corresponding discount amount specified by the corresponding coupon data, and a purchase cost for the requested item; and
transmitting a payment due notification to the processing device, the payment due notification comprising the amount of payment due.

20. The method of claim 19 further comprising:
determining at the processor the amount of payment due is equal to a first payment amount when the purchase request comprises the benefit data; and
determining at the processor the amount of payment due is equal to a second payment amount when the purchase request does not comprises the benefit data.

21. The method of claim 19 further comprises:
comparing, at the other processor, the benefit plan to a list of eligible benefit plans stored in a benefit table to identify in a matching benefit plan, the benefit table comprising the list of eligible benefit plans and corresponding benefit amounts for each eligible benefit plan, wherein the validation response specifies the benefit amount for the matching benefit plan; and
determining the benefit amount for the matching benefit plan at the other processor.

22. The method of claim 19 wherein:
the purchase data comprises an item type, an item amount, and a manufacturer name;
the benefit data comprises a beneficiary identification number, a processing control number, and a group name, a customer name; and
the method further comprises identifying, at the processor, the benefit provider and the benefit plan based on at least one of the beneficiary identification number, the processing control number, and the group name.

23. The method of claim 19 further comprising generating a coupon receipt for display and/or printing at the processor.

24. The method of claim 19 further comprising:
generating a dispensed coupon notification at the processor, the dispensed coupon notification comprising the corresponding coupon identification for the particular coupon identified as available; and
transmitting the dispensed coupon notification to a coupon management system, wherein the coupon management system is configured to identify the coupon record comprising the corresponding coupon identification and to update a coupon count included in the coupon record for storage in the database.

25. The method of claim 19 further comprising determining at the processor the payment amount based only on the corresponding discount amount when the purchase request does not comprise benefit data.

26. The method of claim 19 wherein the benefit amount comprises a co-payment amount, and the method further comprises adjusting the corresponding discount amount not to exceed the co-payment amount at the processor.

27. The method of claim 19 further comprising:
receiving another purchase request at the processor, the other purchase request comprising different purchase data identifying another requested item; and
generating another query at the processor to:
first search the corresponding coupon data for the particular coupon previously stored in the memory;
compare the other requested item to the corresponding coupon data to determine if there is match coupon data;
identify the particular coupon as available for the other requested item when there is matching coupon data;
second search the plurality of coupon records stored in the coupon database when there is no matching coupon data; and
compare the other requested item to the coupon data comprised in each of the coupon records to identify another particular coupon as available for the purchase request.

28. A computer readable media encoded with an application comprising modules executable by a processor and configured to dispense coupons in response to a purchase request received from a computing device, the application comprising:
a query module to:
receive the purchase request, the purchase request comprising purchase data, and the purchase data identifying a requested item;
generate a query to search a plurality of coupon records stored in a coupon database, wherein each of the plurality of coupon records comprise coupon data identifying a coupon, a corresponding coupon identification code, a corresponding discount amount, and corresponding eligible items;
compare the requested item to the coupon data comprised in each of the coupon records to identify a particular coupon as available for the purchase request;
a payment calculation module to calculate an amount of payment due for the requested item based on the corresponding discount amount specified by the corresponding coupon data, and a purchase cost for the requested item; and
a coupon generation module to transmit a payment due notification to the computing device, the payment due notification comprising the amount of payment due.
